(19) United States
(12) Patent Application Publication
(10) Pub. No.: US 2013/0112610 A1
(43) Pub. Date: May 9, 2013

(54) MICROSIEVE USING CARBON NANOTUBES

(71) Applicant: Brigham Young University, a Non-Profit Organization, PROVO, UT (US)

(72) Inventors: ANDREW L. DAVIS, PROVO, UT (US); ROBERT C. DAVIS, PROVO, UT (US); RICHARD R. VANFLEET, PROVO, UT (US)

(73) Assignee: Brigham Young University, a Non-Profit Organization, Provo, UT (US)

(21) Appl. No.: 13/624,083

(22) Filed: Sep. 21, 2012

Related U.S. Application Data
(60) Provisional application No. 61/538,439, filed on Sep. 23, 2011.
(60) Provisional application No. 61/627,919, filed on Oct. 20, 2011.

(51) Int. Cl. B01D 71/02

(52) U.S. Cl. CPC B01D 71/021; Y10S 977/742; B82Y 30/00
USPC 210/321.6; 427/244; 427/243; 205/109; 205/105; 210/500.22; 210/495; 977/742; 977/847

(57) ABSTRACT

A microsieve includes a patterned forest of vertically grown and aligned carbon nanotubes with a patterned matrix of vertically aligned pores. A conformal coating of substantially uniform thickness coats the nanotubes defining coated nanotubes. An interstitial material infiltrates the carbon nanotube forest and substantially fills interstices between individual coated nanotubes. The interstitial material can be a metal material infiltrated by electroplating.

### PRIORITY CLAIM

Priority of U.S. Provisional Patent Application Ser. No. 61/538,439, filed on Sep. 23, 2011, is claimed, which is hereby incorporated herein by reference in its entirety.

Priority of U.S. Provisional Patent Application Ser. No. 61/627,919, filed on Oct. 20, 2011, is claimed, which is hereby incorporated herein by reference in its entirety.

### BACKGROUND

1. Field of the Invention

The present invention relates generally to filters or microsieves using coated and infiltrated carbon nanotube (CNT) forests, and a method of manufacturing such microsieves.

2. Related Art

Microsieves have been used for many microfiltration processes including blood filtering, semiconductor electronics, and water purification. Microsieves have been fabricated from several materials such as: silicon nitride (Si₃N₄), polymers, and metals. Si₃N₄ microsieves can withstand high temperature and are chemically inert, but are much more expensive to produce than polymer microsieves. Polymer microsieves are much cheaper to produce, but are not very resilient to extreme conditions such as high temperature, pressure, or change in pH. Metal microsieves are generally difficult or expensive to produce at thicknesses over a few hundred nm and therefore are extremely fragile.

Microsieving with pore sizes under 10 μm is generally ineffective because the solution flow rate is extremely slow. This could be remedied by pressurizing the solution to increase throughput, however, the maximum allowable pressures for existing microsieves is quite low.

Silicon is a high strength material that has been use to fabricate microsieves. The burst pressure for Si₃N₄ microsieves is ˜1 psi for an 8 mm×8 mm membrane area. In order to increase strength often product developers have to decrease the number of pores per area, which greatly decreases the flow rate. Another problem also faced by microsieve designers is that they are unable to create a large area sieve without difficulty.

Some aspects of carbon nanotubes and microsieves can be found in U.S. Pat. Nos. 7,628,974; 7,756,251; and 8,038,887; and Popp, Alexander et al., Porous Carbon Nanotube-reinforced Metals and Ceramics via a Double-Templating Approach, 47 Carbon 3208 (2009).

### SUMMARY OF THE INVENTION

It has been recognized that it would be advantageous to develop a filter or microsieve that is robust, high strength, low cost, able to handle higher flow rates or without greatly reducing flow rate, and/or has a larger surface area for liquids and/or gases.

The invention provides a method for making a microsieve including obtaining a patterned carbon nanotube forest of vertically grown and aligned carbon nanotubes defining the forest with the nanotubes having a height defining a thickness of the forest. A patterned matrix of vertically aligned pores is aligned with the nanotubes and extends through the thickness of the forest. The pores have a lateral pore size between 0.1 and 99 μm (microns). The nanotubes are coated with a conformal coating of substantially uniform thickness defining coated nanotubes with a coated nanotube diameter greater than the nanotube diameter. The conformal coating connects adjacent nanotubes together, without substantially filling interstices between individual coated nanotubes, and without substantially blocking the pores. The forest of coated nanotubes defines a precursor. The carbon nanotube forest is infiltrated with an interstitial material, different from the conformal coating, and substantially filling interstices between individual coated nanotubes, without substantially blocking the pores.

In accordance with a more detailed aspect of the invention, coating the nanotubes can include coating the nanotubes with a carbon material. Infiltrating the carbon nanotube forest can include infiltrating the carbon nanotube forest with a ceramic or metal interstitial material. Infiltrating the carbon nanotube forest can include infiltrating the carbon nanotube forest in a wet process by immersing the precursor in a liquid bath. Infiltrating the carbon nanotube forest can include electroplating the precursor in a solution with a metal source and an applied current to infiltrate a metallic material into interstices between individual coated nanotubes. Electroplating can further include: attaching an electrode to the precursor, defining a cathode; obtaining a metal source coupled to another electrode, defining an anode; immersing the cathode and anode in an electroplating solution; and applying a current across the anode and the cathode causing metal ions from the solution to attach to the cathode and metal ions from the anode to flow into the solution to recharge the solution, thus infiltrating metal into the carbon nanotube forest. Applying the current can further include pulsing the current. The height of the carbon nanotube forest can be between 3 μm (microns) and 9 mm. Obtaining the patterned forest of vertically grown and aligned carbon nanotubes can further include: patterning a catalyst on a substrate to form a patterned catalyst that matches a desired pattern of the carbon nanotube forest including a matrix of apertures in the patterned catalyst; and growing the nanotubes from the catalyst. The coated nanotubes can be removed from the substrate after coating and prior to infiltrating.

In addition, the invention provides a microsieve including a patterned forest of vertically grown and aligned carbon nanotubes defining a carbon nanotube forest with the nanotubes having a height defining a thickness of the forest. A patterned matrix of vertically aligned pores is defined by the patterned forest, and is aligned with the nanotubes, and extends through the thickness of the forest. The pores have a lateral pore size between 0.1 and 99 μm (microns). A conformal coating of substantially uniform thickness coats the nanotubes, defining coated nanotubes. The coating connects adjacent nanotubes together, without substantially filling interstices between individual coated nanotubes, and without substantially blocking the pores. An interstitial material infiltrates the carbon nanotube forest and substantially fills interstices between individual coated nanotubes without substantially blocking the pores. The pores have opposite free openings that are substantially exposed defining a flow path through the pores.

In accordance with a more detailed aspect of the invention, the carbon nanotube forest and the interstitial material infiltrating the carbon nanotube forest can define a substantially solid body except for the pores, and without openings through the body larger than the pores. The interstitial material can include a metallic material electroplated onto the coated nanotubes. The interstitial material can include carbon and the metallic material. The thickness of the carbon nanotube forest can be between 3 μm (microns) and 9 mm. A fluid line or fluid source can be in fluid communication with the carbon nanotube forest and the pores; and can define the flow path transverse to the carbon nanotube forest and aligned with the pores, with the carbon nanotube forest spanning the fluid line or an orifice of fluid source. A collar or perimeter support can carry the carbon nanotube forest and can secure the carbon nanotube forest in a flow path of a fluid with the fluid passing through the pores.

Furthermore, the invention provides a method for making a microsieve including obtaining a carbon nanotube forest of vertically grown and aligned carbon nanotubes defining the carbon nanotube forest with the nanotubes having a height defining a thickness of the forest and a nanotube diameter. The nanotubes are coated with a conformal coating of substantially uniform thickness defining coated nanotubes with a coated nanotube diameter greater than the nanotube diameter. The coating connects adjacent nanotubes together, without substantially filling interstices between individual coated nanotubes. The forest of coated nanotubes defines a precursor. The carbon nanotube forest is infiltrated with an interstitial material, different from the conformal coating, and substantially fills interstices between individual coated nanotubes to form a substantially non-porous solid body. The coated nanotubes are removed from the body, leaving a plurality of pores defined by the coated nanotubes and extending through a thickness of the body. The pores have a lateral pore size of between 1 and 199 nm (nanometers).

In accordance with a more detailed aspect of the invention, coating the nanotubes can include coating the nanotubes with a carbon material. Removing the coated nanotubes can include heating the coated nanotubes to an elevated temperature to burn the coated nanotubes out of the body. Infiltrating the carbon nanotube forest can include infiltrating the carbon nanotube forest with a ceramic or metal interstitial material. Infiltrating the carbon nanotube forest can include infiltrating the carbon nanotube forest in a wet process by immersing the precursor in a liquid bath. Infiltrating the carbon nanotube forest can include electroplating the carbon nanotube forest in a solution with a metal source and an applied current to infiltrate a metallic material into interstices between individual coated nanotubes. Electroplating can further include: attaching an electrode to the precursor, defining a cathode; obtaining a metal source coupled to another electrode, defining an anode; immersing the cathode and anode in an electroplating solution; and applying a current across the anode and the cathode causing metal ions from the solution to attach to the cathode and metal ions from the anode to flow into the solution to recharge the solution, thus infiltrating metal into the carbon nanotube forest. Applying the current can further include pulsing the current. The height of the carbon nanotube forest can be between 3 μm (microns) and 9 mm. Obtaining the carbon nanotube forest of vertically grown and aligned carbon nanotubes can further include: applying a catalyst on a substrate; and growing the nanotubes from the catalyst. The coated nanotubes can be removed from the substrate after coating and prior to infiltrating. The nanotubes can be grown to optimize density, height and/or straightness, independent of pore size. The pore size can be determined independently with respect to pore density, pore height and pore straightness, with the pore size determined by the coating thickness, and the pore density, pore height and/or pore straightness determined by nanotube growth. The pore size can be determined by two separate steps, including growing the nanotubes and coating the nanotubes.

In addition, the invention provides a method for making a microsieve including obtaining a carbon nanotube forest of vertically grown and aligned carbon nanotubes defining the carbon nanotube forest. The nanotubes have a height defining a thickness of the forest. The nanotubes have hollow interiors defining pores extending through the thickness of the forest. The nanotubes have inner diameters less than 0.5 nm (nanometers). The nanotubes are coated with a conformal coating of substantially uniform thickness defining coated nanotubes. The coating connects adjacent nanotubes together, without substantially filling interstices between individual coated nanotubes. The forest of coated nanotubes defines a precursor. The carbon nanotube forest is infiltrated with a metal interstitial material, different from the conformal coating, and substantially filling interstices between individual coated nanotubes to form a substantially non-porous solid body except for the pores, and without openings through the body larger than the pores.

In accordance with a more detailed aspect of the invention, coating the nanotubes can include coating the nanotubes with a carbon material Infiltrating the carbon nanotube forest can include infiltrating the carbon nanotube forest in a wet process by immersing the precursor in a liquid bath. Infiltrating the carbon nanotube forest can include electroplating the carbon nanotube forest in a solution with a metal source and an applied current to infiltrate a metallic material into interstices between individual coated nanotubes. Electroplating can further include: attaching an electrode to the precursor, defining a cathode; obtaining a metal source coupled to another electrode, defining an anode; immersing the cathode and anode in an electroplating solution; and applying a current across the anode and the cathode causing metal ions from the solution to attach to the cathode and metal ions from the anode to flow into the solution to recharge the solution, thus infiltrating metal into the carbon nanotube forest.

Furthermore, the invention provides a microsieve including a forest of vertically grown and aligned carbon nanotubes defining a carbon nanotube forest with the nanotubes having a height defining a thickness of the forest. The nanotubes have hollow interiors defining pores extending through the thickness of the forest and having inner diameters less than 0.5 nm (nanometers). A conformal coating of substantially uniform thickness coats the nanotubes defining coated nanotubes and connects adjacent nanotubes together, without substantially filling interstices between individual coated nanotubes, and without substantially blocking the pores. A metal interstitial material infiltrates the carbon nanotube forest and substantially fills interstices between individual coated nanotubes, without substantially blocking the pores, and defining a substantially solid body except for the pores, and without openings through the body larger than the pores.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a partial, cross-sectional perspective schematic view of a microsieve in accordance with an embodiment of the invention;

FIG. 1b is a partial expanded schematic view of the microsieve of FIG. 1a, taken along line 1b in FIG. 1a;

FIG. 2a is a scanning electron microscope (SEM) picture of a microsieve in accordance with an embodiment of the invention;

FIG. 2b is a scanning electron microscope (SEM) picture of a microsieve in accordance with an embodiment of the invention shown with particulate trapped or filtered by the microsieve;

FIG. 2c is a scanning electron microscope (SEM) picture of a microsieve in accordance with an embodiment of the invention showing the infiltration of the nickel;

FIG. 2d is a scanning electron microscope (SEM) picture of a microsieve in accordance with an embodiment of the invention showing the infiltration of the nickel;

FIG. 2e is a scanning electron microscope (SEM) picture of a microsieve in accordance with an embodiment of the invention showing the infiltration of the nickel;

FIG. 2f is a scanning electron microscope (SEM) picture of a microsieve in accordance with an embodiment of the invention showing the coated surface of the carbon nanotubes;

FIG. 2g is a scanning electron microscope (SEM) picture of a microsieve in accordance with an embodiment of the invention showing the infiltration of the nickel;

FIG. 2h is a scanning electron microscope (SEM) picture of a microsieve in accordance with an embodiment of the invention showing the floor layer;

FIG. 2i is a scanning electron microscope (SEM) picture of a microsieve in accordance with an embodiment of the invention showing the infiltration of the nickel with a plating time of 2 minutes, temperature of 35° C., pulsing of 0.1 μs on and 0.9 μs off, and showing that the pores are clear and good infiltration with no cracking;

FIG. 2j is a scanning electron microscope (SEM) picture of a microsieve in accordance with an embodiment of the invention showing good infiltration of the nickel;

FIG. 2k is a scanning electron microscope (SEM) picture of a microsieve in accordance with an embodiment of the invention showing good infiltration of the nickel, and the floor layer;

FIG. 2l is a scanning electron microscope (SEM) picture of a microsieve in accordance with an embodiment of the invention showing the infiltration of the nickel without cracking;

FIG. 3a is a partial, cross-sectional perspective schematic view of the microsieve of FIG. 1a;

FIG. 3b is a partial, cross-sectional perspective schematic view of the microsieve of FIG. 1a;

FIG. 4 is a schematic view of a method of making the microsieve of FIG. 1a;

FIGS. 5a-d are cross-sectional, side schematic views of a method making a microsieve, where FIG. 4a shows the growth of carbon nanotube forest, FIG. 4b shows the coating of the carbon nanotubes, FIG. 4c shown the infiltration of an interstitial material into interstices between individual coated nanotubes, and FIG. 4d shows the removal of the coated nanotubes leaving the microsieve formed by the interstitial material; and

FIG. 6 is a cross-sectional, side schematic view of a microsieve of nanofilter in accordance with an embodiment of the invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

In describing and claiming the present invention, the following terminology will be used.

As used here, the term “vertically grown” is used to describe nanotubes that are generally grown upward from a substrate or catalyst material. While such nanotubes exhibit a generally vertical attitude, it is to be understood that such tubes are not necessarily perfectly straight or perfectly upright, but will tend to grow, twist or otherwise meander laterally to some degree, as would be appreciated by one of ordinary skill in the art.

As used herein, the term “aligned” is used to describe nanotubes that generally extend in a common direction from one side or surface to another. While such nanotubes exhibit a generally or substantial alignment, it is to be understood that such tubes are not necessarily perfectly straight or perfectly aligned, but will tend to extend, twist or otherwise meander laterally to some degree, as would be appreciated by one of ordinary skill in the art.

As used herein, relative terms, such as “upper,” “lower,” “upwardly,” “downwardly,” “vertically,” etc., are used to refer to various components, and orientations of components, of the systems discussed herein, and related structures with which the present systems can be utilized, as those terms would be readily understood by one of ordinary skill in the relevant art. It is to be understood that such terms are not intended to limit the present invention but are used to aid in describing the components of the present systems, and related structures generally, in the most straightforward manner. For example, one skilled in the relevant art would readily appreciate that a “vertically grown” carbon nanotube turned on its side would still constitute a vertically grown nanotube, despite its lateral orientation.

As used herein, the term “interstitial” material is used to refer to a material that at least partially fills interstices, or small spaces, between or in individual nanotubes that form an array or forest of nanotubes.

As used herein, the term “pore” refers to a passage or an opening or a void or a hole or a bore formed in the carbon nanotube forest. A pore can be completely devoid of material, and can have walls defined by the carbon nanotubes, the interstitial material used to fill interstices between and/or in the carbon nanotubes, or both.

As used herein, the term “interlocked” is to be understood to refer to a relationship between two or more carbon nanotubes in which the nanotubes are held together, to at least some degree, by forces other than those applied by an interstitial coating or filling material. Interlocked nanotubes may be intertwined with one another (e.g., wrapped about one another), or they may be held together by surface friction forces, van der Waals forces, and the like.

When nanotubes are discussed herein as being “linearly arranged” or “extending linearly,” it is to be understood that the nanotubes, while possibly being slightly twisted, curved, or otherwise meandering laterally, are generally arranged or grown so as to extend lengthwise. Such an arrangement is to be distinguished from nanotubes that are randomly dispersed throughout a medium.

As used herein, the term “substantially” refers to the complete or nearly complete extent or degree of an action, characteristic, property, state, structure, item, or result. As an arbitrary example, when an object or group of objects is/are referred to as being “substantially” symmetrical, it is to be understood that the object or objects are either completely symmetrical or are nearly completely symmetrical. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As an arbitrary example, an opening that is “substantially free of material would either completely lack material, or so nearly completely lack material that the effect would be the same as if it completely lacked material. In other words, an opening that is “substantially free of material may still actually contain some such material as long as there is no measurable effect as a result thereof.

### Description

The present invention provides high strength, low cost microsieves or filters for both liquid and gas filtration. The microsieves were developed using carbon nanotube templated microfabrication (CNT-M). The microsieves are fabricated by growing patterned forests of vertically aligned carbon nanotubes (CNT) with patterned pores followed by an infiltration of interstices between individual nanotubes of the forest with an interstitial material. The interstitial material can include carbon, a metallic material, or both. The infiltration by the interstitial material can be accomplished by electroplating. The process is compatible with the fabrication of microsieves or filters with pore sizes from below one micron up to tens of microns. Straight, vertical pores result in low flow resistance and the high strength carbon material is compatible with high pressure filtering. Initial filtration testing on sample filters with 5 micron pores showed greater than 99.5% removal efficiencies of 6 micron particles.

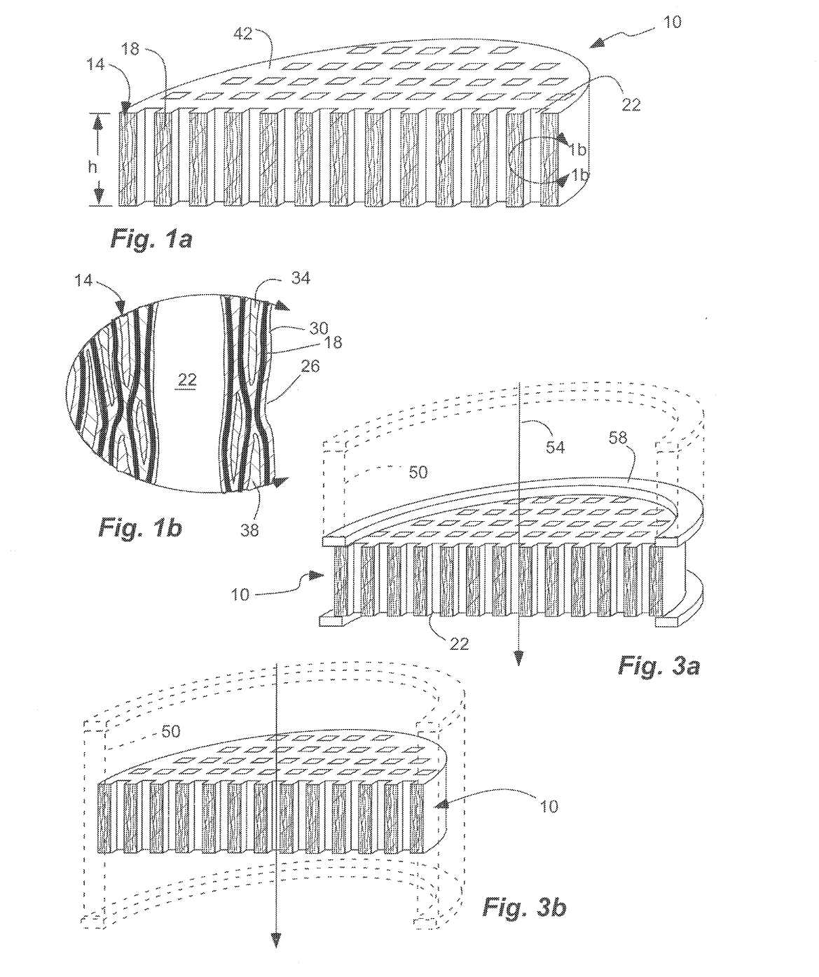

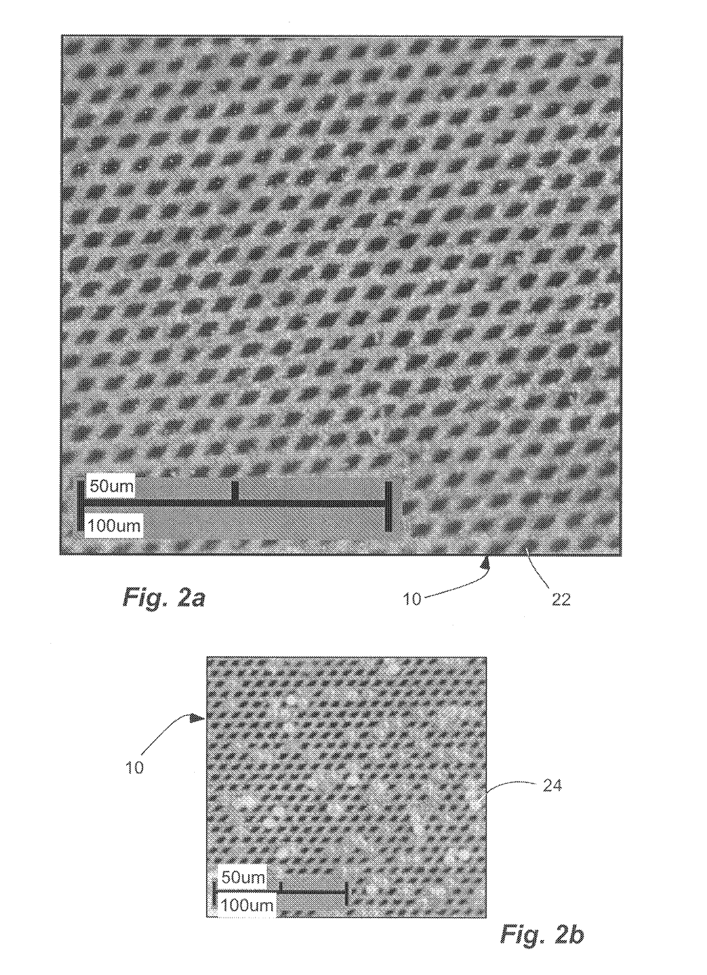

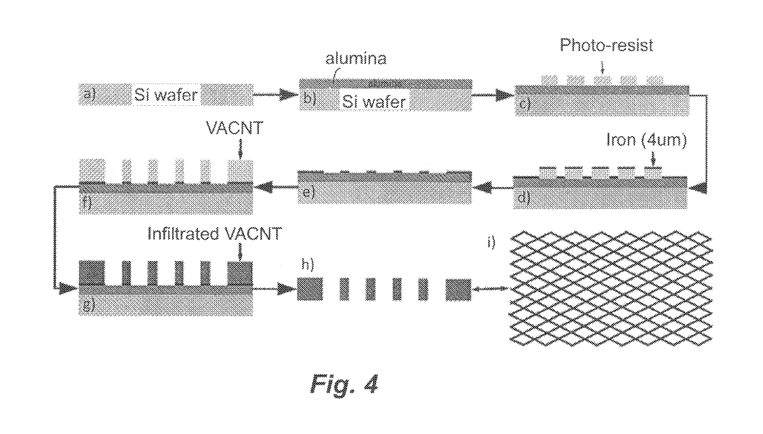

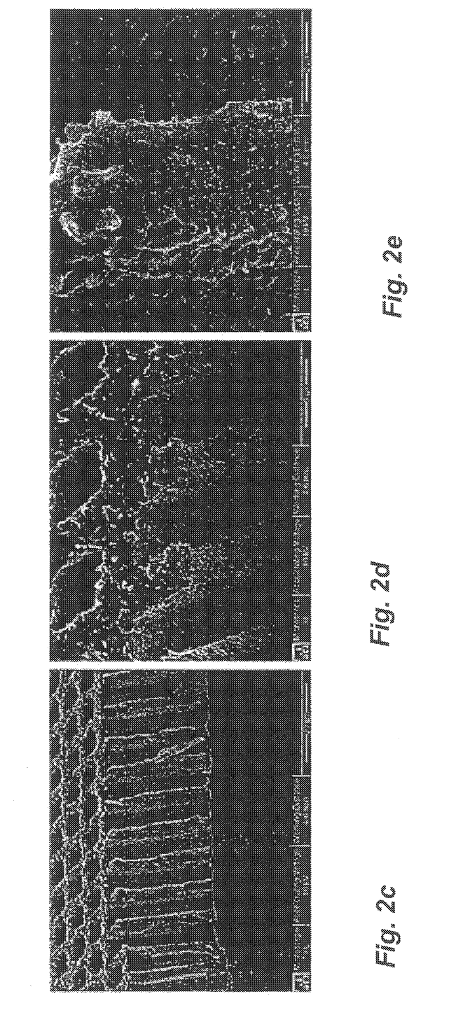

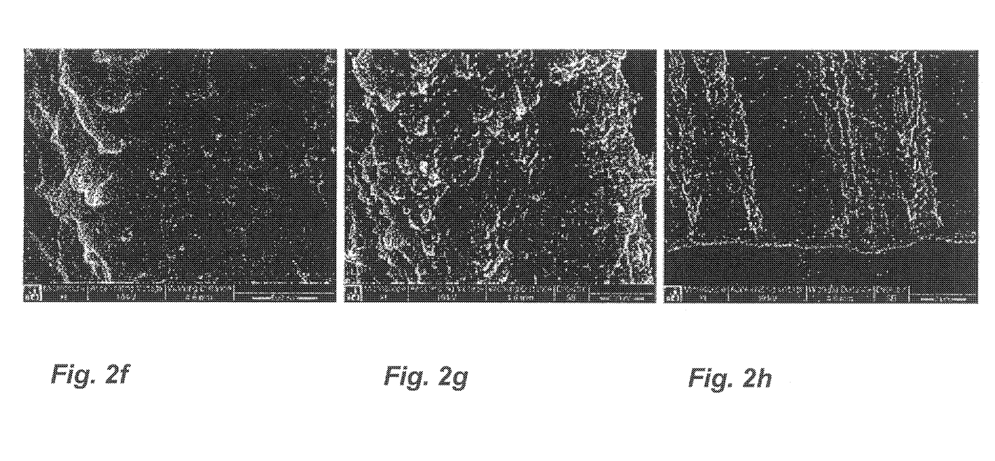

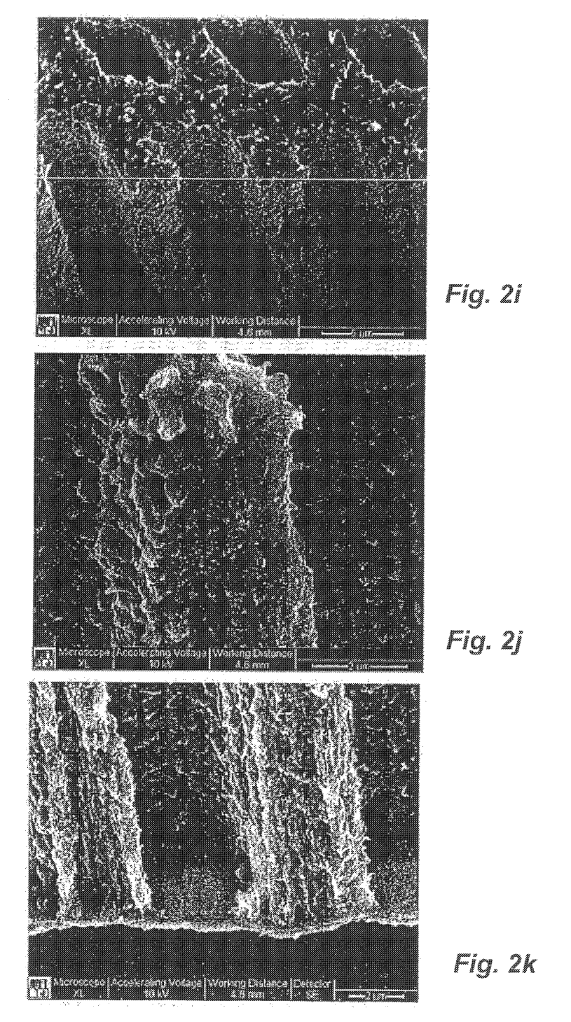

As illustrated in FIGS. 1a-2b, a microsieve, indicated generally at 10, in an example implementation in accordance with the invention is shown for filtering liquids, gases or both. The microsieve 10 includes a patterned forest 14 of carbon nanotubes 18 (CNTs). An exemplary grouping of CNTs is illustrated schematically at 18 to show the generally linear arrangement of the CNTs from one side of the microsieve to the other. The nanotubes 18 are vertically grown and substantially aligned with one another. Thus, the nanotubes substantially extend from one side of the microsieve to the other. The nanotubes 10 have a height h that defines a thickness of the forest 14. Thus, the height h of the nanotubes 18 defines the height of the forest 14 and the thickness or height of the microsieve 10. The height or the thickness of the carbon nanotube forest, and thus the height or length of the nanotubes and the thickness or height of the microsieve, can be between 3 μm (microns) and 9 mm. While not so required, the microsieve formed in accordance with the present invention can include a generally planar face and a generally planar base, with the CNTs of the microsieve extending from the face to the base. While the faces and bases of the example shown in the figure are generally planar, it is to be understood that the faces and/or the bases may include a curvature.

The forest in patterned in that the nanotubes are grown in a deliberate pattern, or from a deliberate area. The microsieve 10 and the forest 14 have a patterned matrix of vertically aligned pores 22. The pores extend through the thickness of the forest, and through the thickness of the microsieve. The pores are defined by the patterned forest and are aligned with the nanotubes. The pores have a lateral pore size, i.e. a width or diameter taken perpendicularly to a longitudinal axis of the pores and nanotubes, between 0.1 and 99 μm (microns). The pores 22 define a flow path for the fluids, while excluding other particulates 24 (FIG. 2b), inclusions, impurities or the like with a size greater than the lateral pore size. The pores have opposite free openings that are substantially exposed.

A conformal coating 26 coats the nanotubes 18. The coating 26 conforms to the shape and direction of the nanotubes. The coating 26 has a substantially uniform thickness along and around the nanotube. The coating 26 on the nanotubes 18 defines coated nanotubes 30. The coated nanotubes 30 can have a coated nanotube diameter greater than the nanotube diameter. The coating between adjacent nanotubes can extend radially or laterally towards one another to form a connection between adjacent coating, and thus adjacent nanotubes. Thus, the coating connects adjacent nanotubes together. The coating can create or define a precursor that is stronger and more capable of withstanding further treatment and manufacturing, such as wet processing, as discussed in greater detail below. The coating 26, however, does not substantially fill interstices 34 between individual coated nanotubes. In addition, the coating 26 does not substantially blocking of fill the pores 22. The coating material can include or can be a carbon material, such as a nanocrystalline carbon.

An interstitial material 38 infiltrates the carbon nanotube forest 14 and substantially fills interstices 34 between individual coated nanotubes 30, but without substantially blocking the pores. The interstices 34 between the nanotubes 18 can be filed with the coating 26 and the interstitial material 38. The interstitial material 38 can be different from the coating material. The interstitial material can include or can be a metallic material.

The pores or the lateral pore size can be significantly greater than the thickness of the coating and the size of the interstices and the nanotubes. For example, the carbon nanotubes can have a diameter of approximately 1 nm (nanometer) (or 0.001 micrometer), while the pores can have a diameter of 0.1 or more μm (microns). Thus, the interstitial material 38 infiltrating and filling the carbon nanotube forest 14 defines a substantially solid body 42 except for the pores 22. The body can be non-porous, with the only porosity or flow paths being defined by the pores. Thus, the body can be devoid of openings through the body larger than the pores. The interstitial material includes a metallic material electroplated onto the coated nanotubes. The electroplating process can be a wet process with the nanotube forest held together by the coating.

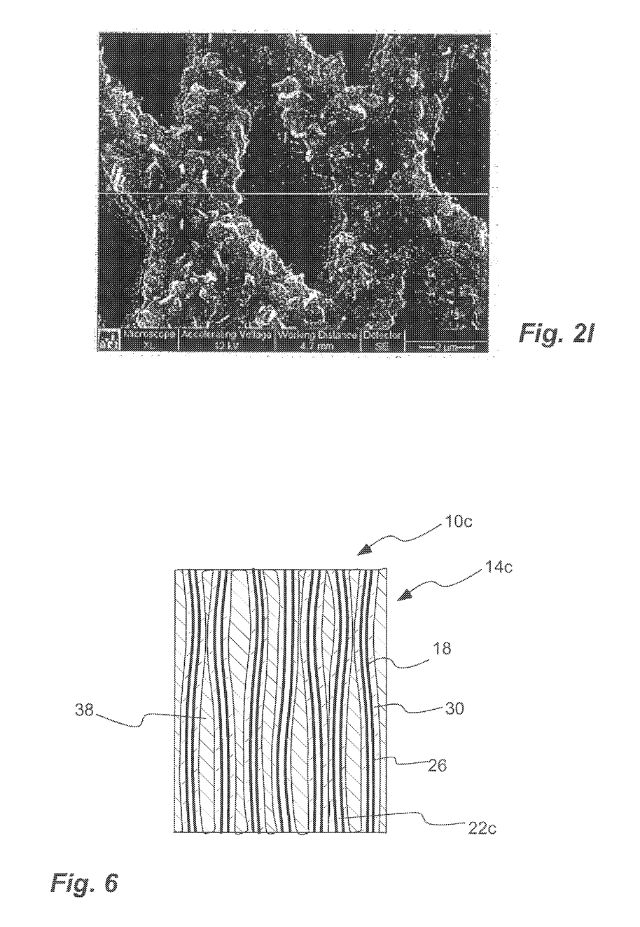

Referring to FIGS. 3a and 3b, the microsieve 10 can be disposed in or in fluid communication with a fluid line or fluid source 50. Thus, the carbon nanotube forest 14 and the pores 22 can be in fluid communication with the fluid line or source 50. The pores and the fluid line 22 or source 50 can define the flow path 54 transverse to the carbon nanotube forest and aligned with the pores. The microsieve 10 and the carbon nanotube forest 14 can spanning the fluid line 50 or an orifice of fluid source. The microsieve 10 can include a collar 58 or perimeter support carrying the carbon nanotube forest 14 and securing the carbon nanotube forest in the flow path 54 of the fluid with the fluid passing through the pores, as shown in FIG. 3a. As described above, the microsieve 10 can be, or can include, a metal such as nickel, which is chemically stable and tough.

A method for making a microsieve 10 described above includes obtaining a patterned carbon nanotube forest 14 of vertically grown and aligned carbon nanotubes 18 defining the forest, with the nanotubes having a height h defining a thickness of the forest, and a patterned matrix of vertically aligned pores 22 aligned with the nanotubes and extending through the thickness of the forest. A catalyst can be patterned on a substrate to form a patterned catalyst that matches a desired pattern of the carbon nanotube forest including a matrix of apertures in the patterned catalyst. The catalyst can be patterned to form pores having a lateral pore size between 0.1 and 99 μm (microns). For example, a silicon wafer can be coated with alumina and a photo-resist layer. The photo-resist layer can be patterned using photolithography. A pattern can be printed onto the photo-resist layer using an electron beam or light exposure.

The unwanted and unexposed resist is washed away. An iron layer can be deposited on the photo-resist layer and the alumina layer. In one aspect, the iron layer can be 2-20 nm thick. In another aspect, the iron layer can be 4 nm thick. The unwanted layer of iron on the photo-resist can be removed by removing the photo-resist, exposing the alumina layer. Thus, the iron layer is patterned and becomes a patterned catalyst that will define the carbon nanotube forest, while the exposed alumina patterns or defines the pores. The nanotubes can be grown from the catalyst. The nanotubes can be grown using chemical vapor deposition (“CVD”) process. For example, the nanotubes can be grown in a quartz tube (gas inlet and exhaust) placed in a furnace at a temperature of 750° C. at flow rates of Argon(Ar) 375 sccm; hydrogen (H₂) 400 sccm; and ethylene (C₂H₄) 600 sccm. The hydrogen can flow while the tube is heated and then the ethylene flowtime determines the amount of growth. The nanotubes can be grown to have a height between 3 μm (microns) and 9 mm. The nanotubes 18 are coated with a conformal coating 26 of substantially uniform thickness defining coated nanotubes 30. The nanotubes can be coated through chemical vapor deposition (CVD). For example, the nanotubes can be coated with a carbon material, such as nanocrystalline carbon. The coating can be applied in the quartz tube in the furnace at a temperature of 900° C. at flow rates of Argon(Ar) 125 sccm; hydrogen (H₂) 80 sccm; and ethylene (C₂H₄) 300 sccm. Carbon from the ethylene gas is deposited on the individual nanotubes. The time can be adjusted to determine the coating thickness. The hydrogen can be flowed during carbon infiltration to resist or prevent the forest from detaching from the substrate. The coating 26 can connect adjacent nanotubes together, but not substantially filling interstices 34 between individual coated nanotubes, and not substantially blocking the pores 22. In one aspect, the nanotubes 18 can be coated with the coating material 26 while the nanotubes extend from and are coupled to the substrate. Thus, the coated nanotubes can be removed from the substrate after coating, and prior to infiltrating. In another, the nanotubes 18 can be coated with the coating material and the forest can be infiltrated with the interstitial material while the nanotubes extend from and are coupled to the substrate. Thus, the coated nanotubes can be removed from the substrate after coating, and after infiltrating. The forest of coated nanotubes defines a precursor. The carbon nanotube forest 14 is infiltrated with an interstitial material 38, different from the conformal coating 26, and substantially filling interstices 34 between individual coated nanotubes without substantially blocking the pores. In one aspect, the coated nanotubes or the forest or the precursor can be removed from the substrate using a reactive ion etcher to expose the underlying layer and a wet etch to remove that sacrificial layer. In another aspect, the coated nanotubes or the forest or the precursor can be removed after infiltration using a solution of 40% HF to etch the oxide layer.

In one specific example of the invention, CNTs can be grown by first preparing a sample by applying 30 nm of alumina on an upper surface of a supporting silicon wafer. A patterned, 4 nm iron (Fe) film can be applied to the upper surface of the alumina. The resulting sample can be placed on a quartz “boat” in a one inch quartz tube furnace and heated from room temperature to about 750 degrees C. while flowing 500 sccm of H₂. When the furnace reaches 750 degrees C. (after about 8 minutes), a C₂H₄ flow can be initiated at 700 sccm (if slower growth is desired, the gases may be diluted with argon). After a desired CNT length (or height) is obtained, the H₂ and C₂H₄ gases can be removed, and Ar can be initiated at 350 sccm while cooling the furnace to about 200 degrees C. in about 5 minutes.

The above example generated patterned CNTs with an average diameter of about 8.5 nm and a density of about 9.0 kg/m³. It was also found that the conditions above produced a CNT “forest” of high density, interlocked or intertwined CNTs that can be grown very tall while maintaining very narrow features in the patterned frame.

The intertwining of the CNT during growth can be advantageous in that the CNTs maintain a lateral pattern (generally defined by a catalyst from which the CNTs are grown) while growing vertically upward, as the CNTs maintain an attraction to one another during growth. Thus, rather than achieving random growth in myriad directions, the CNTs collectively maintain a common, generally vertical attitude while growing.

Formation of the patterned forest can be accomplished in a variety of manners. Referring to FIG. 4, a series of processes exemplary of one manner of doing so is shown. The process can begin at frame (b) of FIG. 4, where 30 nm of alumina is evaporated by electron beam evaporation onto a SiO₂ substrate. At (c), AZ330 photo resist is spun and patterned (note that the pattern is not evident from the view of FIG. 4—it would be apparent from a top view of the substrate). At (d), iron (Fe), such as 4 nm, is thermally evaporated on top of the photo resist. At (e), the photo resist is lifted off in a resist stripper. At (f), a forest of generally vertically-aligned CNTs is grown from the patterned iron film by chemical vapor deposition at 750 degrees C. using C₂H₄ and H₂ feedstock gases (note that, while the CNTs are shown schematically as generally straight and upright, there will likely be a considerable amount of intertwining or interlocking of the CNTs as they are grown). At (g), the CNT forest is coated and/or infiltrated by suitable materials by various chemical vapor deposition processes (e.g., low-pressure, atmospheric, high-pressure CVD, etc.).

While not specifically illustrated in FIG. 4, it will be appreciated by one of ordinary skill in the art having possession of this disclosure that coating and/or infiltration step illustrated in frame (g) will often result a “floor layer” of interstitial or infiltration material being applied near the base of the patterned frame within the passages defined by the CNTs (e.g., at the bottom of “wells” or “cups” formed by the passages and the Al₂O₃). This floor layer can be removed in order to expose the underlying sacrificial layer for etching. The removal of the floor layer can be accomplished in a number of manners. In one aspect of the invention, a short reactive ion etch can be utilized. For example, a Reactive Ion Etch (RIE) can be accomplished at 100 W, 100 mTorr, flowing 3.1 sccm of O₂ and 25 sccm of CF₄, etching for 5-9 minutes (depending on the size of the features being etched). In another example, a CH₃F/0₂ Inductively Coupled Plasma RIE etch can be utilized. It is also contemplated that a wet etch can be utilized, for example by placing the sample in KOH or a similar solution to etch away the floor layer.

While each of these process may result in etching or removing some of the interstitial material from the CNT forest, it has been found that the floor layer is removed before significant etching of the structure CNT structure occurs. Generally speaking, creation of the “floor layer,” and subsequent removal of the floor layer, will be considerations in most of the processes utilized in coating or infiltrating the CNT patterned forest.

At (h), the underlying SiO₂ is etched to release portions of the structure. This can be accomplished in a number of manners, including by immersion in HF. Depending upon the desired configuration of the patterned forest, all of the forest can be removed from the substrate, or only some of the forest can be removed from the substrate.

Removal of the forest from the substrate can be accomplished in a number of manners. In one aspect, the forest can be simply pried off the substrate using mechanical force. Other embodiments can include the use of an etching process to remove the underlying sacrificial layer (e.g., SiO₂ in the example given above) or to attack the interface between layers to release the forest from the substrate.

Infiltrating the carbon nanotube forest can include infiltrating the carbon nanotube forest with a ceramic or metal interstitial material. For example, the interstitial material can be or can include nickel. The coated nanotubes can be stronger and allow for wet processing. Thus, infiltrating the carbon nanotube forest can include infiltrating the carbon nanotube forest in a wet process by immersing the precursor in a liquid bath. In addition, infiltrating the carbon nanotube forest can include electroplating the precursor in a solution with a metal source and an applied current to infiltrate a metallic material into interstices between individual coated nanotubes. Electroplating can include attaching an electrode to the precursor, defining a cathode. A metal source can be obtained and coupled to another electrode, defining an anode. The anode can be a nickel source. The cathode and anode are immersed in an electroplating solution. The solution or bath can include a nickel chloride or nickel sulfamate. The bath can be heated without excessive heating to avoid cracking. For example, the bath can be at a temperature of approximately 35° C. The PH of the solution can be approximately 4.0. Boric acid can be used to rejuvenate the solution when the PH changes. A current is applied across the anode and the cathode causing metal ions from the solution to attach to the cathode, and metal ions from the anode to flow into the solution to recharge the solution, thus infiltrating metal into the carbon nanotube forest. The applied current can be approximately 0.2 amps, and the voltage can be approximately 2 volts. The current can be pulsed. For example, the current can be pulsed 0.1 μs on and 0.9 is off.

Another filter or microsieve can be made using a coated and infiltrated carbon nanotube forest. The carbon nanotubes can be removed leaving the interstitial material to define the microsieve, with the coated nanotubes being sacrificed to define the pores through the interstitial material and the microsieve. In one aspect, the nanotube forest can be grown without patterning. In another aspect, the carbon nanotube forest can be patternedto define the final shape of the microseive. Coating the nanotubes can define the diameter of the coated nanotubes, and thus the diameter of the pores. In one aspect, the coated nanotubes can have a diameter of between 1 and 199 nm (nanometers). In addition, coating the nanotubes creates a two step process, namely nanotube growth and nanotube coating, that separates the pore size consideration from the consideration of pore density, pore height and pore straightness. Thus, the carbon nanotube forest (density, height and/or straightness) can be determined independently of the carbon nanotube diameter (and subsequent pore diameter). Furthermore, coating the nanotubes can strengthen the forest, creating a precursor that can better tolerate subsequent infiltration, including wet processing.

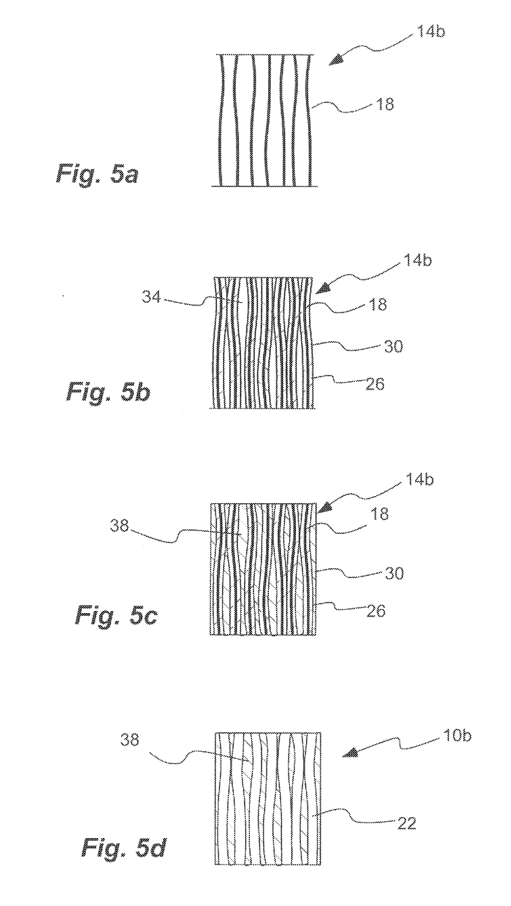

Referring to FIGS. 5a-d, a method for making a microsieve 10b includes obtaining a carbon nanotube forest 14b of vertically grown and aligned carbon nanotubes 18 defining the carbon nanotube forest, as shown in FIG. 5a. The nanotubes 18 have a height defining a thickness of the forest and a nanotube diameter. As stated above, the carbon nanotube forest 14b can be grown to optimize density, height and/or straightness, independent of diameter. In one aspect, an unpatterned catalyst can be disposed on or applied to a substrate. An iron layer, such as 4 nm, can be deposited on the substrate. In another aspect, a catalyst can be patterned on a substrate to form a patterned catalyst that matches a desired pattern of the carbon nanotube forest with the pattern of nanotubes defining the final microsieve shape. For example, a silicon wafer can be coated with alumina and a photo-resist layer. The photo-resist layer can be patterned using photolithography. The unwanted resist is washed away. An iron layer, such as 4 nm, can be deposited on the photo-resist layer and the alumina layer. The unwanted layer of iron on the photo-resist can be removed by removing the photo-resist, exposing the alumina layer. Thus, the iron layer is patterned and becomes a patterned catalyst that will define the carbon nanotube forest, and thus the microsieve shape. The nanotubes can be grown from the catalyst. The nanotubes can be grown using a chemical vapor deposition (“CVD”) process. For example, the nanotubes can be grown for in a quartz tube (gas inlet and exhaust) placed in a furnace at a temperature of 750° C. at flow rates of Argon(Ar) 375 sccm; hydrogen (H₂) 400 sccm; and ethylene (C₂H₄) 600 sccm. The hydrogen can flow while the tube is heated and then the ethylene flows to determine the amount of growth. The nanotubes can be grown to have a height between 3 μm (microns) and 9 mm.

The method includes coating the nanotubes 18 with a conformal coating 26 of substantially uniform thickness defining coated nanotubes 30 with a coated nanotube diameter greater than the nanotube diameter, as shown in FIG. 5b. The coating 26 can connect some adjacent nanotubes together, without substantially filling interstices 34 between individual coated nanotubes. The forest 14b of coated nanotubes 30 defines a precursor. The nanotubes can be coated through chemical vapor deposition (CVD). For example, the nanotubes can be coated with a carbon material, such as nanocrystalline carbon. The coating can be applied in the quartz tube in the furnace at a temperature of 900° C. at flow rates of Argon(Ar) 125 sccm; hydrogen (H₂) 80 sccm; and ethylene (C₂H₄) 300 sccm. Carbon from the ethylene gas is deposited on the individual nanotubes. The time can be adjusted to determine the coating thickness, and thus the pore size. In one aspect, the nanotubes can be coated to have a coated diameter of between 1 and 199 nm (nanometers). The hydrogen can be flowed during carbon infiltration to resist or prevent the forest from detaching from the substrate. The coating process determines the pores size, and is thus independent from the nanotube growth process, that determines the pore density, pore height and/or pore straightness. Thus, the pore size and the pore density, height and/or straightness are determined in a two step process, and are independent of one another.

Referring to FIG. 5c, the method includes infiltrating the carbon nanotube forest 14b with an interstitial material 38 different from the conformal coating 26. In one aspect, the interstitial material can be tungsten or silicon. In another aspect, the interstitial material can be a metallic material applied by electroplating or other wet process. For example, the interstitial material can be or can include nickel infiltrating the coated nanotubes using electroplating. The interstitial material 38 substantially fills the interstices 34 between individual coated nanotubes 30 to form a substantially non-porous solid body.

Infiltrating the carbon nanotube forest can include infiltrating the carbon nanotube forest with a ceramic or metal interstitial material. The coated nanotubes can be stronger and allow for wet processing. Thus, infiltrating the carbon nanotube forest can include infiltrating the carbon nanotube forest in a wet process by immersing the precursor in a liquid bath. In addition, infiltrating the carbon nanotube forest can include electroplating the precursor in a solution with a metal source and an applied current to infiltrate a metallic material into interstices between individual coated nanotubes. Electroplating can include attaching an electrode to the precursor, defining a cathode. A metal source can be obtained and coupled to another electrode, defining an anode. The anode can be a nickel source. The cathode and anode are immersed in an electroplating solution. The solution or bath can include a nickel chloride or nickel sulfamate. The bath can be heated without excessive heating to avoid cracking. For example, the bath can be at a temperature of approximately 35° C. The PH of the solution can be approximately 4.0. Boric acid can be used to rejuvenate the solution when the PH changes. A current is applied across the anode and the cathode causing metal ions from the solution to attach to the cathode, and metal ions from the anode to flow into the solution to recharge the solution, thus infiltrating metal into the carbon nanotube forest. The applied current can be approximately 0.2 amps, and the voltage can be approximately 2 volts. The current can be pulsed. For example, the current can be pulsed 0.1 μs on and 0.9 μs off.

In one aspect, the nanotubes 18 can be coated with the coating material 26 while the nanotubes extend from and are coupled to the substrate. Thus, the coated nanotubes can be removed from the substrate after coating, and prior to infiltrating. In another aspect, the nanotubes 18 can be coated with the coating material and the forest can be infiltrated with the interstitial material while the nanotubes extend from and are coupled to the substrate. Thus, the coated nanotubes can be removed from the substrate after coating, and after infiltrating. The forest of coated nanotubes defines a precursor. The carbon nanotube forest 14 is infiltrated with an interstitial material 38, different from the conformal coating 26, and substantially filling interstices 34 between individual coated nanotubes without substantially blocking the pores. In one aspect, the coated nanotubes or the forest or the precursor can be removed from the substrate using a reactive ion etcher to expose the underlying layer and a wet etch to remove the sacrificial layer. In another aspect, the coated nanotubes or the forest or the precursor can be removed after infiltration using a solution of 40% HF to etch the oxide layer. The ends of the nanotubes can be exposed, such as by polishing or etching, so that the microsieve has open pores when the nanotubes are removed. The microsieve can be etched or polished to expose the nanotubes prior to burning or removing the nanotubes.

Referring to FIG. 5d, the method includes removing the coated nanotubes 30, both the nanotubes 18 and the coating 26, from the body leaving a plurality of pores 22 defined by the coated nanotubes and extending through a thickness of the body, or microsieve 10b. Thus, the microsieve 10b can be formed of nickel. The coated nanotubes can be removed by burning them out, or heating the coated nanotubes to an elevated temperature to burn the coated nanotubes out of the body. The pores have a lateral pore size (width or diameter) of between 1 and 199 nm (nanometers). Thus, the body or microsieve 10b is defined by the remaining interstitial material, while the pores 22 are defined by the sacrificial coated nanotubes. The size or diameter of the pores is defined by the coating, independent of the nanotube density, height and/or straightness. Thus, the nanotubes are grown to optimize density, height and/or straightness, independent of pore size. The pore size is determined independently with respect to pore density, pore height and pore straightness; with the pore size determined by the coating thickness, and the pore density, pore height and/or pore straightness determined by nanotube growth. The pore size is determined by two separate steps, including growing the nanotubes and coating the nanotubes.

Another nanofilter or microsieve can be made using a coated and infiltrated carbon nanotube forest. An interior hollow of the nanotubes can be used as pores or flow channels. The inner diameter of the nanotubes can be very small, i.e. less than 0.5 nm. Such a microsieve, with pore diameters less than 0.5 nm, can be used for desalination because they will allow water through the pores, but not salt ions. Such a microsieve or nanofilter can be used as a reverse osmosis filter or membrane. The microsieve can include a metal, such as nickel or other electrodeposited metals or alloys, which is chemically stable and tough. The microsieve can be coupled to a fluid line or source that is a salt water source.

Referring to FIG. 6, a microsieve or nanofilter 10c is shown, that can be used as part of a desalination system or a reverse osmosis system. Various aspect of microsieves are described above, and such description is herein incorporated by reference. The microsieve 10c includes a forest of vertically grown and aligned carbon nanotubes 18 defining a carbon nanotube forest 14c with the nanotubes having a height defining a thickness of the forest. The nanotubes 18 have hollow interiors defining pores 22c extending through the thickness of the forest and having inner diameters less than 0.5 nm (nanometers). A conformal coating 26 of substantially uniform thickness coats the nanotubes defining coated nanotubes 30. The coating 26 connects adjacent nanotubes together, without substantially filling interstices between individual coated nanotubes, and without substantially blocking the pores. A metal interstitial material 38 infiltrates the carbon nanotube forest and substantially fills interstices between individual coated nanotubes, without substantially blocking the pores, and defining a substantially solid body except for the pores, and without openings through the body larger than the pores.

A method for making a microsieve 10c is similar to that described above, and which description is herein incorporated by reference. The method includes obtaining a carbon nanotube forest 14c of vertically grown and aligned carbon nanotubes 18 defining the carbon nanotube forest with the nanotubes having a height defining a thickness of the forest. The nanotubes 18 have hollow interiors defining pores 22c extending through the thickness of the forest, and having inner diameters less than 0.5 nm (nanometers). The nanotubes 18 are coated with a conformal coating 26 of substantially uniform thickness, defining coated nanotubes 30. The coating 26 connects adjacent nanotubes together, without substantially filling interstices between individual coated nanotubes. The forest of coated nanotubes defines a precursor. The carbon nanotube forest 14c of coated nanotubes 30 is infiltrated with a metal interstitial material; different from the conformal coating, such as nickel. The interstitial material substantially fills interstices between individual coated nanotubes to form a substantially non-porous solid body except for the pores, and without openings through the body larger than the pores. The coating and infiltrating processes are described above. In addition, the ends of the nanotubes (or top and bottom of the microsieve) can be etched or polished to expose the ends of the nanotubes and the pores.

Various aspects of patterned carbon nanotube forests are described and shown in U.S. Pat. No. 7,756,251, which is hereby incorporated herein by reference.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for making a microsieve, comprising:
a) obtaining a patterned carbon nanotube forest of vertically grown and aligned carbon nanotubes defining the forest with the nanotubes having a height defining a thickness of the forest, and a patterned matrix of vertically aligned pores aligned with the nanotubes and extending through the thickness of the forest, the pores having a lateral pore size between 0.1 and 99 μm (microns);
b) coating the nanotubes with a conformal coating of substantially uniform thickness defining coated nanotubes with a coated nanotube diameter greater than the nanotube diameter and connecting adjacent nanotubes together, without substantially filling interstices between individual coated nanotubes, and without substantially blocking the pores, the forest of coated nanotubes defining a precursor; and
c) infiltrating the carbon nanotube forest with an interstitial material different from the conformal coating and substantially filling interstices between individual coated nanotubes without substantially blocking the pores.

2. A method in accordance with claim 1, wherein coating the nanotubes includes coating the nanotubes with a carbon material.

3. A method in accordance with claim 1, wherein infiltrating the carbon nanotube forest includes infiltrating the carbon nanotube forest with a ceramic or metal interstitial material.

4. A method in accordance with claim 1, wherein infiltrating the carbon nanotube forest includes infiltrating the carbon nanotube forest in a wet process by immersing the precursor in a liquid bath.

5. A method in accordance with claim 1, wherein infiltrating the carbon nanotube forest includes electroplating the precursor in a solution with a metal source and an applied current to infiltrate a metallic material into interstices between individual coated nanotubes.

6. A method in accordance with claim 5, wherein electroplating further comprises:
a) attaching an electrode to the precursor, defining a cathode;
b) obtaining a metal source coupled to another electrode, defining an anode;
c) immersing the cathode and anode in an electroplating solution; and
d) applying a current across the anode and the cathode causing metal ions from the solution to attach to the cathode and metal ions from the anode to flow into the solution to recharge the solution, thus infiltrating metal into the carbon nanotube forest.

7. A method in accordance with claim 6, wherein applying the current further comprises:
pulsing the current.

8. A method in accordance with claim 1, wherein the height of the carbon nanotube forest is between 3 μm (microns) and 9 mm.

9. A method in accordance with claim 1, wherein obtaining the patterned forest of vertically grown and aligned carbon nanotubes further comprises:
a) patterning a catalyst on a substrate to form a patterned catalyst that matches a desired pattern of the carbon nanotube forest including a matrix of apertures in the patterned catalyst; and
b) growing the nanotubes from the catalyst; and
wherein the method further comprises:
removing the coated nanotubes from the substrate after coating and prior to infiltrating.

10. A microsieve device, comprising:
a) a patterned forest of vertically grown and aligned carbon nanotubes defining a carbon nanotube forest with the nanotubes having a height defining a thickness of the forest;
b) a patterned matrix of vertically aligned pores defined by the patterned forest and aligned with the nanotubes and extending through the thickness of the forest, the pores having a lateral pore size between 0.1 and 99 μm (microns);
c) a conformal coating of substantially uniform thickness coating the nanotubes defining coated nanotubes and connecting adjacent nanotubes together, without substantially filling interstices between individual coated nanotubes, and without substantially blocking the pores;
d) an interstitial material infiltrating the carbon nanotube forest and substantially filling interstices between individual coated nanotubes without substantially blocking the pores; and
e) the pores having opposite free openings that are substantially exposed defining a flow path through the pores.

11. A device in accordance with claim 10, wherein the carbon nanotube forest and the interstitial material infiltrating the carbon nanotube forest define a substantially solid body except for the pores, and without openings through the body larger than the pores.

12. A device in accordance with claim 10, wherein the interstitial material includes a metallic material electroplated onto the coated nanotubes.

13. A device in accordance with claim 12, wherein the interstitial material includes carbon and the metallic material.

14. A device in accordance with claim 10, wherein the thickness of the carbon nanotube forest is between 3 μm (microns) and 9 mm.

15. A device in accordance with claim 10, further comprising:
a fluid line or fluid source in fluid communication with the carbon nanotube forest and the pores, and defining the flow path transverse to the carbon nanotube forest and aligned with the pores, and with the carbon nanotube forest spanning the fluid line or an orifice of fluid source.

16. A device in accordance with claim 10, further comprising:
a collar or perimeter support carrying the carbon nanotube forest and securing the carbon nanotube forest in a flow path of a fluid with the fluid passing through the pores.

17. A method for making a microsieve, the method comprising:
a) obtaining a carbon nanotube forest of vertically grown and aligned carbon nanotubes defining the carbon nanotube forest with the nanotubes having a height defining a thickness of the forest and a nanotube diameter;
b) coating the nanotubes with a conformal coating of substantially uniform thickness defining coated nanotubes with a coated nanotube diameter greater than the nanotube diameter and connecting adjacent nanotubes together, without substantially filling interstices between individual coated nanotubes, the forest of coated nanotubes defining a precursor;
c) infiltrating the carbon nanotube forest with an interstitial material different from the conformal coating and substantially filling interstices between individual coated nanotubes to form a substantially non-porous solid body; and
d) removing the coated nanotubes from the body leaving a plurality of pores defined by the coated nanotubes and extending through a thickness of the body, the pores having a lateral pore size of between 1 and 199 nm (nanometers).

18. A method in accordance with claim 17, wherein coating the nanotubes includes coating the nanotubes with a carbon material.

19. A method in accordance with claim 17, wherein removing the coated nanotubes includes heating the coated nanotubes to an elevated temperature to burn the coated nanotubes out of the body.

20. A method in accordance with claim 17, wherein infiltrating the carbon nanotube forest includes infiltrating the carbon nanotube forest with a ceramic or metal interstitial material.

21. A method in accordance with claim 17, wherein infiltrating the carbon nanotube forest includes infiltrating the carbon nanotube forest in a wet process by immersing the precursor in a liquid bath.

22. A method in accordance with claim 17, wherein infiltrating the carbon nanotube forest includes electroplating the carbon nanotube forest in a solution with a metal source and an applied current to infiltrate a metallic material into interstices between individual coated nanotubes.

23. A method in accordance with claim 22, wherein electroplating further comprises:
a) attaching an electrode to the precursor, defining a cathode;
b) obtaining a metal source coupled to another electrode, defining an anode;
c) immersing the cathode and anode in an electroplating solution; and
d) applying a current across the anode and the cathode causing metal ions from the solution to attach to the cathode and metal ions from the anode to flow into the solution to recharge the solution, thus infiltrating metal into the carbon nanotube forest.

24. A method in accordance with claim 23, wherein applying the current further comprises:
pulsing the current.

25. A method in accordance with claim 17, wherein the height of the carbon nanotube forest is between 3 μm (microns) and 9 mm.

26. A method in accordance with claim 17, wherein obtaining the carbon nanotube forest of vertically grown and aligned carbon nanotubes further comprises:
a) applying a catalyst on a substrate; and
b) growing the nanotubes from the catalyst; and
wherein the method further comprises:
removing the coated nanotubes from the substrate after coating and prior to infiltrating.

27. A method in accordance with claim 17, wherein the nanotubes are grown to optimize density, height and/or straightness, independent of pore size.

28. A method in accordance with claim 17, wherein the pore size is determined independently with respect to pore density, pore height and pore straightness, with the pore size determined by the coating thickness, and the pore density, pore height and/or pore straightness determined by nanotube growth.

29. A method in accordance with claim 17, wherein the pore size is determined by two separate steps, including growing the nanotubes and coating the nanotubes.

30. A method for making a microsieve, the method comprising:
a) obtaining a carbon nanotube forest of vertically grown and aligned carbon nanotubes defining the carbon nanotube forest with the nanotubes having a height defining a thickness of the forest, the nanotubes having hollow interiors defining pores extending through the thickness of the forest and having inner diameters less than 0.5 nm (nanometers);
b) coating the nanotubes with a conformal coating of substantially uniform thickness defining coated nanotubes and connecting adjacent nanotubes together, without substantially filling interstices between individual coated nanotubes, the forest of coated nanotubes defining a precursor; and
c) infiltrating the carbon nanotube forest with a metal interstitial material, different from the conformal coating, and substantially filling interstices between individual coated nanotubes to form a substantially non-porous solid body except for the pores, and without openings through the body larger than the pores.

31. A method in accordance with claim 30, wherein coating the nanotubes includes coating the nanotubes with a carbon material.

32. A method in accordance with claim 30, wherein infiltrating the carbon nanotube forest includes infiltrating the carbon nanotube forest in a wet process by immersing the precursor in a liquid bath.

33. A method in accordance with claim 30, wherein infiltrating the carbon nanotube forest includes electroplating the carbon nanotube forest in a solution with a metal source and an applied current to infiltrate a metallic material into interstices between individual coated nanotubes.

34. A method in accordance with claim 33, wherein electroplating further comprises:
a) attaching an electrode to the precursor, defining a cathode;
b) obtaining a metal source coupled to another electrode, defining an anode;
c) immersing the cathode and anode in an electroplating solution; and
d) applying a current across the anode and the cathode causing metal ions from the solution to attach to the cathode and metal ions from the anode to flow into the solution to recharge the solution, thus infiltrating metal into the carbon nanotube forest.

35. A microsieve device, comprising:
a) a forest of vertically grown and aligned carbon nanotubes defining a carbon nanotube forest with the nanotubes having a height defining a thickness of the forest;
b) the nanotubes having hollow interiors defining pores extending through the thickness of the forest and having inner diameters less than 0.5 nm (nanometers);
c) a conformal coating of substantially uniform thickness coating the nanotubes defining coated nanotubes and connecting adjacent nanotubes together, without substantially filling interstices between individual coated nanotubes, and without substantially blocking the pores; and
d) a metal interstitial material infiltrating the carbon nanotube forest and substantially filling interstices between individual coated nanotubes without substantially blocking the pores, and defining a substantially solid body except for the pores, and without openings through the body larger than the pores.
